(19) United States
(12) Patent Application Publication
(10) Pub. No.: US 2021/0406818 A1
(43) Pub. Date: Dec. 30, 2021

(54) Monitoring Device, System, and Method

(71) Applicant: Oliack Holdings LLC, Mahwah, NJ (US)

(72) Inventors: Matthew ADLER, Mahwah, NJ (US); Rami REFAELI, Moshav Yarhiv (IL)

(73) Assignee: Oliack Holdings LLC, Mahwah, NJ (US)

(21) Appl. No.: 17/289,846

(22) PCT Filed: Nov. 27, 2019
(86) PCT No.: PCT/US19/63599

§ 371 Date: Apr. 29, 2021

Related U.S. Application Data
(60) Provisional application No. 62/773,808, filed on Nov. 30, 2018.

(51) Int. Cl. G06Q 10/08; G06Q 50/28

(52) U.S. Cl. CPC G06Q 10/0832; G06Q 50/28; G06Q 10/0833

(57) ABSTRACT

A system includes at least one monitoring device, with each monitoring device associated with a respective item, wherein each monitoring device monitors a state of the respective item relative to a first parameter; a server for communicating with the monitoring devices, for storing a list of identifiers, and for storing states of the monitoring devices, wherein each identifier is at uniquely identifies a respective item; a user computer associated with a user and operatively connected to the server, the user computer including: an input device for inputting a first identifier and for communicating the first identifier to the server; and an output device for outputting to the user a first state of a first monitoring device corresponding to the first identifier; wherein the first state of the first monitoring device corresponds to a state of a first item with the first item associated with the first monitoring device.

### CROSS-REFERENCE TO RELATED APPLICATION

This application claims priority to U.S. Provisional Application No. 62/773,808, filed on Nov. 30, 2018, which is incorporated by reference in its entirety.

### FIELD

The present disclosure relates to monitoring devices and in particular to a system, method, and device for monitoring items.

### BACKGROUND

Cases and other types of containers hold one or more items. Such cases are used for transporting items such as by shipping or mailing such item-laden cases from an originating source to a destination. In some instances, cases are used to transport valuable items and in these instances the owners of the valuable items may wish to track and monitor them.

Therefore, a need exists for tracking and monitoring the conditions and locations of such items and/or cases or containers containing such items.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

A device is associated with a case holding an item using an attachment member which is secure enough such that the device stays with the case as the case is shipped, mailed, or otherwise transported from a starting point to a destination point. The device includes a printed circuit board (PCB) and at least one sensor for determining and monitoring the state of the case, such as various real-time parameters and/or the real-time location of the case using GPS. The various real-time parameters are measured by the at least one sensor and include at least one of the amount of light which the case is subjected to in the ambient environment of the inside of the case, the temperature of the case, the humidity of the case, the pressure experienced by the case, any vibrations of the case, and any shocks experienced by the case. Other known measurements may be added and measured by sensors or other means, such as the temperature of the case, the air quality in the ambient environment of the case, and/or different states of the case, etc.

The at least one sensor relays the location and/or the measured parameters to the PCB, which in turn transmits data representing the location and the parameters via a network, such as the Internet, a cloud-based network, or any other known communication methods and protocols, to a web server. The web server includes a set of services which processes the received case data and which generates a presentation layer, which a user accesses to retrieve and display the location, the measured parameters of the device to track the case in a user interface and/or some analytics driven by methods that extract the state of the case in different scenarios.

The device of the present invention is powered by a battery and includes software to optimize and improve the battery usage in a wireless and GSM communication system to maximize the battery lifetime. The software is comprised of a logic process by which the device enters into a sleep mode when the device is in a steady mode (not moving) for a configurable period and wakes up when it is moved or when some of the sensors, as described above, exceed a configurable threshold. The logic also places the device in a sleep mode when moving for a specific and configurable period and when nothing accrued or a specific latitude. Also, the device has an option to wirelessly charge the battery without connecting it to the power using a Qi wireless charger.

In one embodiment, the present invention is a system including a network; at least one monitoring device operatively connected to the network, with each monitoring device associated with a respective item, wherein each monitoring device monitors a state of the respective item relative to a first parameter, wherein the first parameter is selected from the group consisting of ambient light, humidity, air pressure, vibration, shock, temperature, air quality, and location; a server for communicating with the at least one monitoring device through the network, for storing a list of a plurality of identifiers, and for storing a plurality of states of the at least one monitoring device, wherein each identifier is at least one character which uniquely identifies a respective item; and a user computer associated with a user and operatively connected to the server through the network, the user computer including: an input device for inputting a first identifier and for communicating the first identifier to the server; and an output device for outputting to the user a first state of a first monitoring device corresponding to the first identifier; wherein the first state of the first monitoring device corresponds to a state of a first item of the plurality of items with the first item associated with the first monitoring device. The user computer includes an input/output device having a graphical user interface for implementing the input device and the output device. The network is the Internet. The first monitoring device is attached to the first item by an attachment member. Alternatively, the first item is a container, and the first monitoring device is inside the container. The output device includes a display which displays a dashboard indicating the first state. The dashboard allows the user to monitor the state of the first item. Alternatively, the dashboard allows the user to monitor the health of the first item, wherein the health is determined from the first state using a predetermined algorithm.

In another embodiment, the present invention includes a system including at least one monitoring device, with each monitoring device associated with a respective item, wherein each monitoring device monitors a state of the respective item relative to a first parameter, wherein the first parameter is selected from the group consisting of ambient light, humidity, air pressure, vibration, shock, temperature, air quality, and location; a server for communicating with the at least one monitoring device, for storing a list of a plurality of identifiers, and for storing a plurality of states of the at least one monitoring device, wherein each identifier is at least one character which uniquely identifies a respective item; and a user computer associated with a user and operatively connected to the server, the user computer including: an input device for inputting a first identifier and for communicating the first identifier to the server; and an output device for outputting to the user a first state of a first monitoring device corresponding to the first identifier; wherein the first state of the first monitoring device corresponds to a state of a first item of the plurality of items with the first item associated with the first monitoring device. The system further includes a network for connecting the at least one monitoring device, the server, and the user computer. The output device includes a display which displays a dashboard indicating the first state. The dashboard allows the user to monitor the state of the first item. Alternatively, the dashboard allows the user to monitor the health of the first item, wherein the health is determined from the first state using a predetermined algorithm.

In a further embodiment, the present invention is a system including: a device for monitoring a state of an item relative to a parameter; and a user computer for outputting a health of the item to a user associated with the user computer, wherein the health is determined from the state using a predetermined algorithm. The device is attached to the item by an attachment member. Alternatively, the item is a container, and the device is inside the container.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic of a system of the present invention;

FIG. 2 is a schematic of an alternative embodiment of the system of FIG. 1;

FIG. 3 is a schematic of components in a device of the present invention;

FIG. 4 is a top front perspective view of the device of the present invention in a partially open configuration; and

FIG. 5 is a top front perspective view of the device of FIG. 4 in a closed configuration.

FIG. 6 is a top front side perspective view of an alternative embodiment of the device of FIGS. 4-5;

FIG. 7 is a top plan view of the device of FIG. 6;

FIG. 8 is a bottom plan view of the device of FIG. 6;

FIG. 9 is a front plan view of the device of FIG. 6;

FIG. 10 is a side plan view of the device of FIG. 6;

FIG. 11 is a flowchart of a method of operation of the present invention;

FIG. 12 is a front plan view of a user computer with a user interface with an input field;

FIG. 13 is a front plan view of the user computer of FIG. 12 with the user interface showing parameters;

FIG. 14 is a front plan view of the user computer of FIG. 12 with the user interface showing a map;

FIG. 15 is a screenshot of a dashboard interface showing the health of devices and associated alerts;

FIG. 16 is a screenshot of the dashboard interface of FIG. 15 showing a reports generation interface;

FIG. 17 is a screenshot of the dashboard interface of FIG. 15 showing a map with parameter values;

FIG. 18 is a screenshot of the dashboard interface of FIG. 15 showing a map with a history of a parameter;

FIG. 19 is a screenshot of the dashboard interface of FIG. 15 showing Conditions Settings;

FIG. 20 is a screenshot of the dashboard interface of FIG. 19 showing Conditions Settings with a pop-up window to set parameters;

FIG. 21 is a screenshot of the dashboard interface of FIG. 19 showing Conditions Settings with a pop-up window to set thresholds; and

FIG. 22 is a screenshot of the dashboard interface of FIG. 15 showing Events with a pop-up window to set threshold parameters.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left may be used to describe the accompanying figures. The terminology includes the words above specifically mentioned, derivatives thereof, and words of similar import.

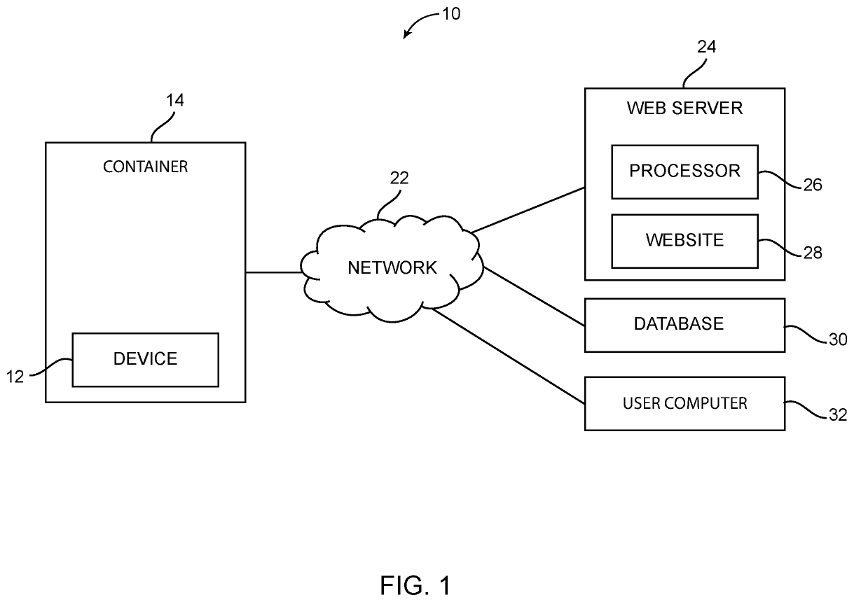

Referring to FIG. 1, in one embodiment, a system 10 has a container 14 which contains a device 12 having internal electronics, as described below, for monitoring the condition inside and/or outside the container 14. The container 14 may be a case, a shipping package, an interior of a movable structure such as a vehicle, or any known structure in which the device 12 is disposed. For example, the container 14 may be a beverage container, i.e., a commercial refrigerator, having beverages stored in a side-by-side configuration or stacked vertically. The device 12 may be used to monitor beverages removed from the container by utilizing sensors within the device 12, e.g., weight, light, etc. Alternatively, the device 12 can be embedded in the case, e.g., luggage or a suitcase.

The device 12 transmits data representing the location and various parameters associated with the device 12 and, in turn, the container 14, via a network 22, such as the Internet, a cloud-based network, or any other known communication methods and protocols, to a web server 24. Such communication methods and protocols may include WiFi, Bluetooth, 4G, 5G or a combination of the same. The web server 24 includes a processor 26 which processes the received data and which generates a website 28. The processor 26 may in turn store the received data and/or the website data in a memory of the web server 24. The memory may be a database in the web server 24, or alternatively may be an external database 30 connected to the web server 24 through the network 22. In a further alternative embodiment, the database 30 may be directly connected to the web server 24 without the use of the network 22, or may be connected to the web server 24 through a different network such as a local area network (LAN). The database 30 may also be a cloud-based database which a user can log into from anywhere.

A user accesses the system 10 by a user computer 32, which may access the data through the website 28, which serves as a user interface (UI) being a web-based interface. The user computer 32 may be a personal computer (PC), a laptop, a tablet, a mobile telephone, a smart phone, or any other known types of computing devices. Accordingly, depending on the embodiment of the user computer 32, the user computer 32 may be mobile for functioning anywhere that the user travels.

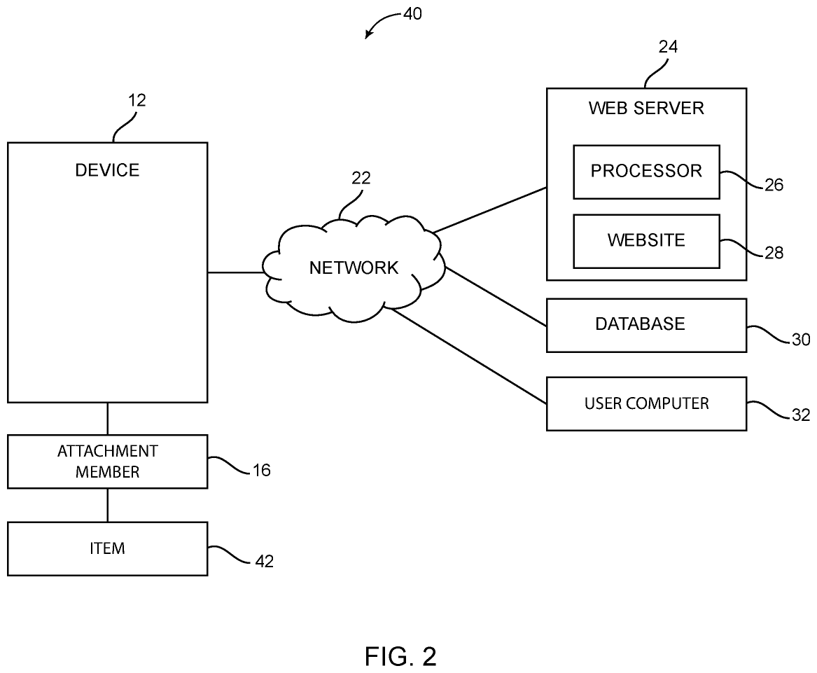

Referring to FIG. 2, in an alternative embodiment, a system 40 of the present invention has the device 12 as a stand-alone device which is associated with an item 42 by use of an attachment member 16. The attachment member 16 can couple or alternatively attach the device 12 to the item 42. For example, the attachment member 16 can be a hook-and-loop fastener, a hook, a clip, or any known device for attaching the device 12 to the item 42. In an alternative embodiment, the attachment member 16 may removably attach the device 12 to the item 42. In another alternative embodiment, the attachment member 16 may be an adhesive such as glue, adhesive tape, epoxy, or any other known adhesive for attaching the device 12 to the item 42. The adhesive may be removable and/or impermanent so that the device 12 is removably attached to the item 42. However, it is understood that the attachment of the device 12 to the item 42 by any type of attachment member 16 is to be secure enough such that the device 12 stays with the item 42 as the item 42 is shipped, mailed, or otherwise transported from a starting point to a destination point.

Similar to the function of the device 12 described above with reference to FIG. 1, the device 12 in FIG. 2 transmits data representing the location and various parameters associated with the device 12 and, in turn, the item 42, via a network 22, such as the Internet, a cloud-based network, or any other known communication methods and protocols, to a web server 24. Such communication methods and protocols may include WiFi, Bluetooth, 4G, or 5G. The web server 24 includes a processor 26 which processes the received data and which generates a website 28. The processor 26 may in turn store the received data and/or the website data in a memory of the web server 24. The memory may be a database in the web server 24, or alternatively may be an external database 30 connected to the web server 24 through the network 22. In a further alternative embodiment, the database 30 may be directly connected to the web server 24 without the use of the network 22, or may be connected to the web server 24 through a different network such as a local area network (LAN). The database 30 may also be a cloud-based database which a user can log into from anywhere.

A user accesses the system 10 by a user computer 32, which may access the data through the website 28, which serves as a user interface (UI) being a web-based interface. The user computer 32 may be a personal computer (PC), a laptop, a tablet, a mobile telephone, a smart phone, or any other known types of computing devices. Accordingly, depending on the embodiment of the user computer 32, the user computer 32 may be mobile for functioning anywhere that the user travels.

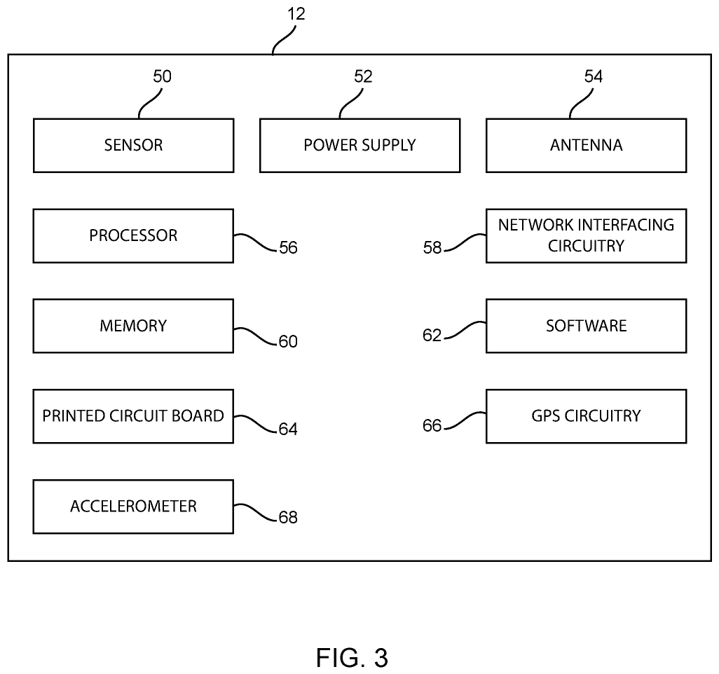

As shown in FIG. 3, the device 12 has various components to provide the functionality described above, such as at least one of a sensor 50, a power supply 52, an antenna 54, a processor 56, network interfacing circuitry 58, a memory 60, software 62, and a printed circuit board (PCB) 64, with various interconnections between the components 50-68 in any manner known in the art. The memory 60 may be any type of memory, such as a SIM card, which may also be used by a telephone service provider to locate to the device 12 without using GPS. Alternatively, the memory 60 may be separate from a SIM card which does not store data.

The sensor 50 may include a plurality of different sensors. The sensor 50 determines and monitors the state of the device 12, and in turn the state of the container 14 or the state of the item 42, shown in FIGS. 1-2, respectively. The monitored state includes various real-time parameters and/or the real-time location of the device 12 using GPS or other location systems or methods. Accordingly, the device 12 may include the GPS circuitry 66 for accessing satellite communications to determine the real-time location of the device 12, as well as an accelerometer 68 for measuring movement of the device 12. The various real-time parameters are measured by the sensor 50 and include at least one of the amount of light which the device 12 is subjected to in the ambient environment of the device 12, the humidity of the device 12, the pressure experienced by the device 12, any vibrations of the device 12 detected by the accelerometer, and any shocks experienced by the device 12 detected by the accelerometer 68. Other known measurements may be measured by the sensor 50, such as the temperature of the device 12, the air quality in the ambient environment of the device 12, etc. Furthermore, the sensor 50 may measure any weight on the device 12. For example, the sensor 50 may be attached to a bottom container of a beverage, and so may determine the weight of any containers above the bottom container, thereby facilitating the monitoring of the weight and, thus, the number of containers atop the bottom container. The sensor 50 may also determine the open status or closed status of the device 12, the container 14, and/or the item 42.

In one embodiment, the sensor 50 is mounted to the PCB 64. In another embodiment, the sensor 50 is located within the device 12 and is separate from the PCB 64, with the sensor 50 being operatively connected and in communication with the PCB 64. The PCB 64 may also be connected to other peripheral sensors 50 and monitors data from such peripheral sensors 50. The PCB 64 may also include the power supply 52, such as a battery, allowing the device 12 to be mobile when coupled to the device 12 which is in transit. The battery may be rechargeable and may be a lithium (Li) ion battery having a relatively long life. In addition, the PCB 64 may have the network interfacing circuitry 58 onboard, such as circuitry for communicating over the network 22 via WiFi, Bluetooth, 4G, 5G protocols, or a combination thereof, and/or any other known types of communication protocols for interfacing between the PCB 64 and the network 22. The PCB 64 may include the processor 56 and the memory 60. The PCB 64 may also include the antenna 54 for GSM and for GPS to extend the transmission and the reception of each. Alternatively, the antenna 54 may be separate from the PCB 64 and/or external to the device 12. In addition, the software 62 is embedded in the device 12, and may be used for operating the device 12, its sensors 50, and its networking and communication functionality, and may be embedded on the PCB 64, for example, by being stored in the processor 56 and/or the memory 60 of the PCB 64. The sensor 50 may also relay the location and/or the measured parameters to the PCB 64 for further processing by the other components of the device 12 in FIG. 3.

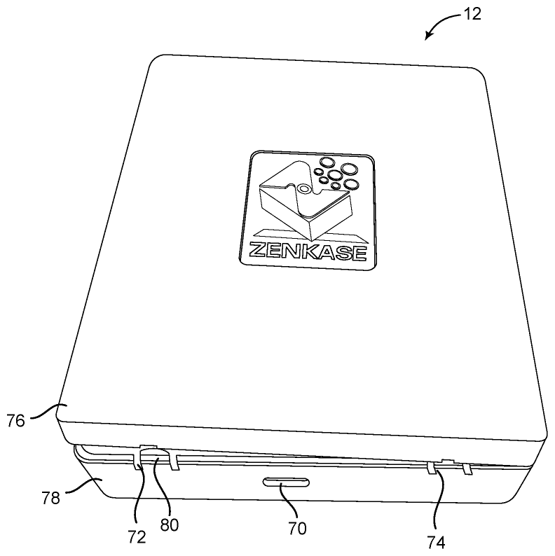

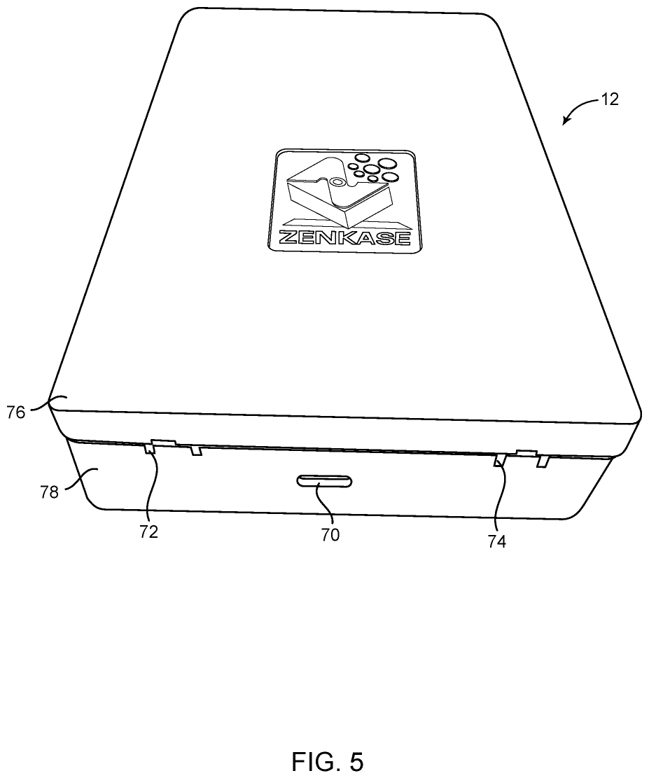

Referring to FIGS. 4-5, in one embodiment, the device 12 is shown with an outer casing for serving as an enclosure in which the PCB 64, the sensor 50, and the other components shown in FIG. 3 are disposed internally. A port 70 is provided which may have different functions. For example, the port 70 may provide a connection to an external power source, such as a 120 V or 240 V power socket or plug, to recharge the rechargeable battery as the power supply 52 of the device 12. Alternatively, the port 70 may be a communication port for facilitating the transfer of data to or from the device 12. In another alternative embodiment, the port 70 may be a USB port which may serve both as a recharging port as well as a data port. At least one fastener 72, 74 is provided. The outer casing may include a top member 76 and a bottom member 78, which may be composed of plastic, metal, or any other known materials, and which are secured together by the fasteners 72, 74. As shown in FIG. 4, the outer casing may be ajar with the top member 76 being not fully coupled with the bottom member 78. At least one tab 80 may be provided, for example, on the bottom member 78 to allow the members 76, 78 to snap together to be coupled by the tab 80 engaging a detent (not shown) or other internal structures of the top member 76. With the members 76, 78 uncoupled and separated from each other, a technician can service and/or replace various components, such as replace a battery of the power supply 52. As shown in FIG. 5, the members 76, 78 are coupled together, such as by a friction fit. In one embodiment, the members 76, 78 are separate components which may be removably coupled together. In another embodiment, the members 76, 78 may be coupled internally on one side by at least one hinge (not shown), allowing the top member 76 to be rotatably moved about the hinge to fully engage the bottom member 78. Preferably, the device 12 includes a fastener such as screws or a lock such that the top and bottom members 76, 78 remain engaged during transport of the device 12. The lock could be a key lock that requires a key to unlock or a digital lock that requires a passcode to open. Alternatively, the lock could be operably coupled with the network 22 such that the device 12 could be unlocked remotely by the user via electronic signal, or on a smart app using a mobile device scanning a fingerprint of the user.

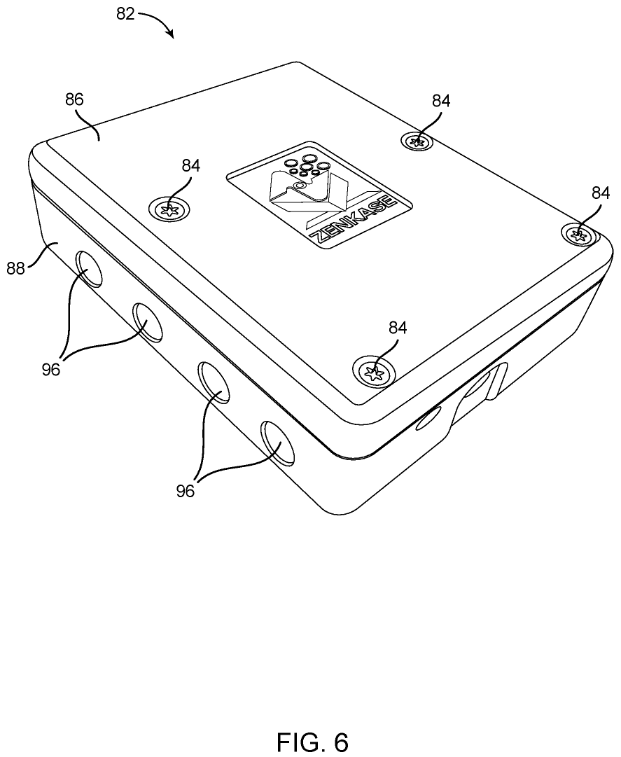

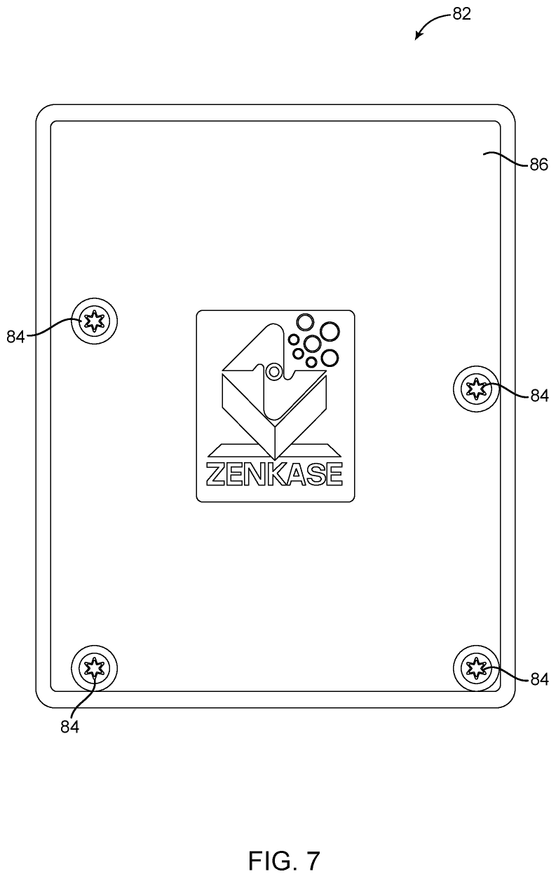

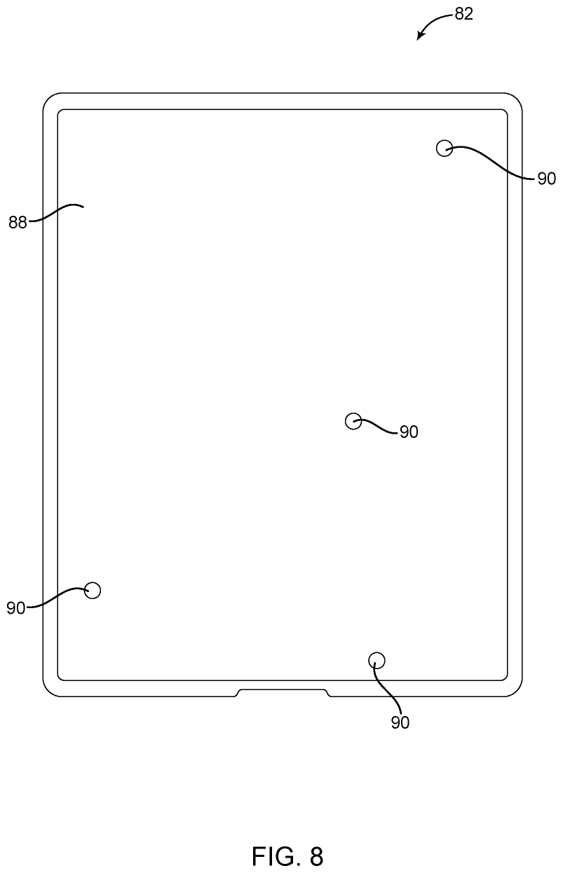

As shown in FIGS. 6-10, in an alternative embodiment, a device 82 is substantially similar to the device 12 described above, and so may include some or all of the components 50-68 shown in FIG. 3. However, the device 82 has fasteners 84 removably securing a top member 86 from a bottom member 88. As shown in FIG. 8, the device 82 also has lights 90 or other illumination elements, such as light emitting diodes (LEDs), which are illuminated to indicate the status of the device 82. For example, one light 90 may be red and may indicate that the device 82 is on and monitoring for various parameters, while a different light 90 may indicate an active connection with the network 22 and/or other components such as the web server 24 or the user computer 32, for facilitating transmission of gathered data from the device 82 to the network 22, web server 24, or user computer 32. The various lights 90 may have different colors signifying different states of the device 82.

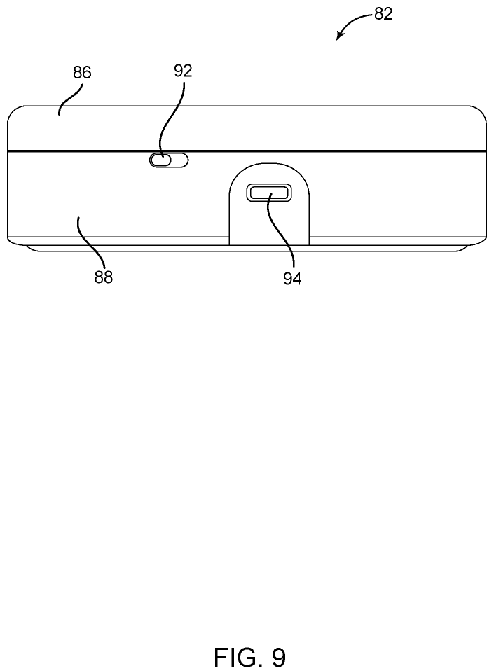

Referring to FIG. 9, the device 82 has an on/off switch 92 for activating or deactivating the device 82. In addition, the device 82 has a port 94 which may have different functions. For example, the port 94 may provide a connection to an external power source, such as a 120 V or 240 V power socket or plug, to recharge the rechargeable battery as the power supply 52 of the device 82. Alternatively, the port 94 may be a communication port for facilitating the transfer of data to or from the device 82. In another alternative embodiment, the port 94 may be a USB port which may serve both as a recharging port as well as a data port.

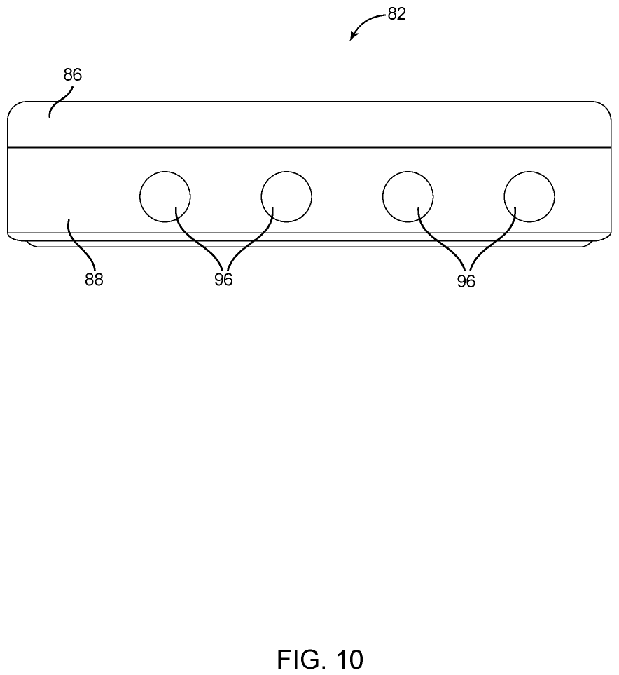

Referring to FIG. 10, the device 82 has at least one port 96, which may be apertures in the side wall of the device 82, and which allow the sensors 50 to communicate with the external ambient environment of the device 82, and so to measure parameters of the external ambient environment, such as temperature, humidity, and air pressure. The at least one port 96 may also provide plug-and-play capability for attaching external sensors to the device 82.

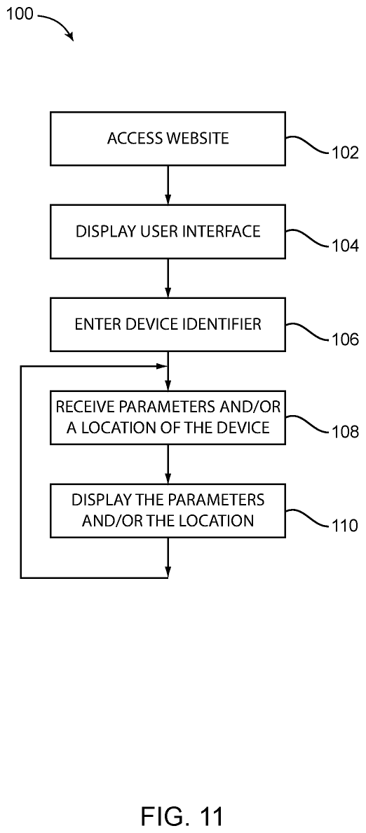

Referring to FIG. 11, a method 100 of operation includes the steps of the user accessing the website 28 by the user computer 32 in step 102, and the user computer 32 displaying a UI on a display of the user computer 32 in step 104. Then the user enters a device identifier which uniquely identifies each device 12, 82 and thus the container 14 or the item 42 associated with the specifically identified device 12, 82 in step 106. The user computer 32 receives the measured parameters and/or a location of the device 12, 82 having the device identifier from the web server 24 in step 108, and the user computer 32 then displays the parameters and/or the location of the device 12 to the user in step 110. The method 100 then loops back to repeat steps 108 and 110 to update the parameters and/or the location of the device 12, 82 being displayed to the user through the user computer 32.

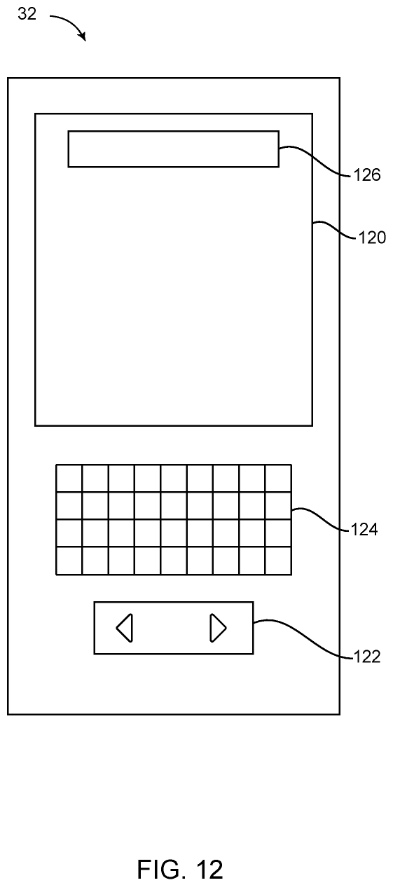

Referring to FIGS. 12-14, the user computer 32 includes a display 120, such as a screen which may be an LCD display, an LED display, an OLED display, or any other known types of displays. The display 120 may optionally be touch sensitive, allowing a user to interact with data and icons on the display 120. The user computer 32 also has at least one control, such as buttons 122, a keypad, and/or a keyboard 124 allowing the user to enter alphanumeric data and/or navigation commands, and also to scroll through available user selections, data, and icons displayed on the display 120.

Referring to FIG. 12 in conjunction with FIGS. 1-2, after the user accesses the website 28 in step 42, the display 120 may display the user interface as a web-based interface and/or as a cloud-based application, including an input field 126, in which the user enters the unique device identifier in step 46 using the at least one control such as an alphanumeric keyboard 124 and/or a numeric keypad. Since each device 12, 82 has a unique corresponding device identifier, and each device 12, 82 is associated with a specific container 14 or item 42 due to the coupling by the attachment member 16, entry and processing of the unique device identifier in step 46 causes the web server 24 to access the corresponding data of the device 12, 82, with the data retrieved from a memory in the web server 24 and/or database 30. The system 10, 40 then sends such data to the user computer 32 so that the user computer 32 receives such measured parameters and/or the location of the device 12 corresponding to the unique corresponding device identifier in step 48.

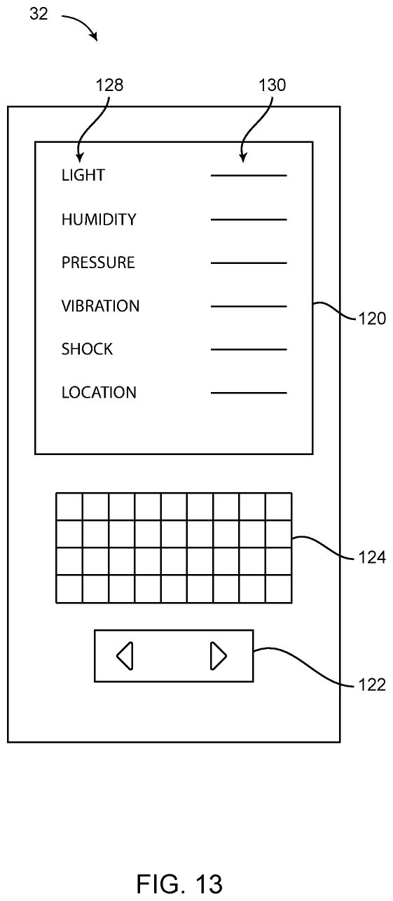

Referring to FIG. 13 in conjunction with FIGS. 1-2, after the user computer 32 receives the data in step 48, the user computer 32 displays the data, including the parameters and/or the location in the display 120 in step 50. To perform step 50, the user computer 32 controls the display 120 to generate a list 128 of labels as the names of the parameters, such as light, temperature, humidity, pressure, vibration, shock, as well as the label for a location. The user computer 32 then controls the display 120 to generate a set of output fields 130 in which text and/or numerical values of the parameters and/or the location are correspondingly displayed adjacent to a respective label in the list 128, with the text and/or numerical values being derived from the data received in step 48.

The output fields 130 may display text for the parameters and/or the location such as “HIGH”, “MEDIUM”, and “LOW” for relatively high, medium, and low amounts, respectively, of light, humidity, pressure, etc. For the location, the corresponding output field 130 may display relative distances such as “FAR” or “NEAR”, or may display the name of a city at which the device 12, 82 and its associated container 14 or item 42 are near.

Alternatively, the output fields 130 may display numerical values for the parameters and/or the location. For the parameters, the numerical values may have corresponding units of text, such as “LUMENS” for the amount of ambient light, a percentage or “GRAMS PER CUBIC METER” for the humidity, “PSI” or “PASCALS” for the pressure, etc. For the location, the numerical values may be the current longitude and latitude of the device 12, 82. Alternatively, the location may be expressed numerically by the number of miles or kilometers away from the destination point.

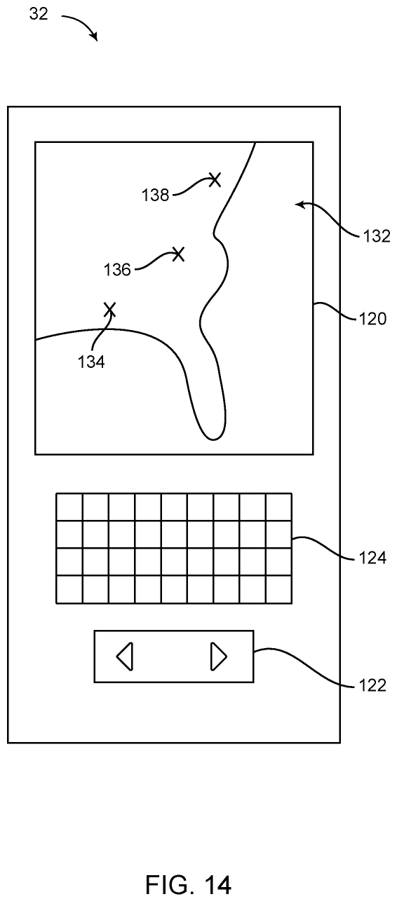

Referring to FIG. 14, the user may control the user computer 32, using the controls such as the buttons 122 and/or the keyboard 124, to display a map 132 on the display 120, which shows the starting point 134, the current location 136, and the destination location 138 of the device 12, 82 and its associated container 14 or item 42. Alternatively, the map 132 may show only the current location 136. In a further alternative embodiment, the map 132 may show a sequence of dots or line segments indicating the path over which the device 12, 82 is travelling, which may be generated by the web server 24 and/or the user computer 32 from multiple saved values of the current locations of the device 12, 82. Accordingly, using the configurations of the display 120 in FIGS. 3-5, the user has live access to real-time measurement data and location data, as well as a history of locations of the device 12, 82 on the map 132. In addition, timestamps may be displayed at the bottom of the map 132, with the timestamps corresponding to the time when the device 12, 82 is at a given current location 136. The map 132 may also show geocoding of the latitude and longitude of the device 12, 82.

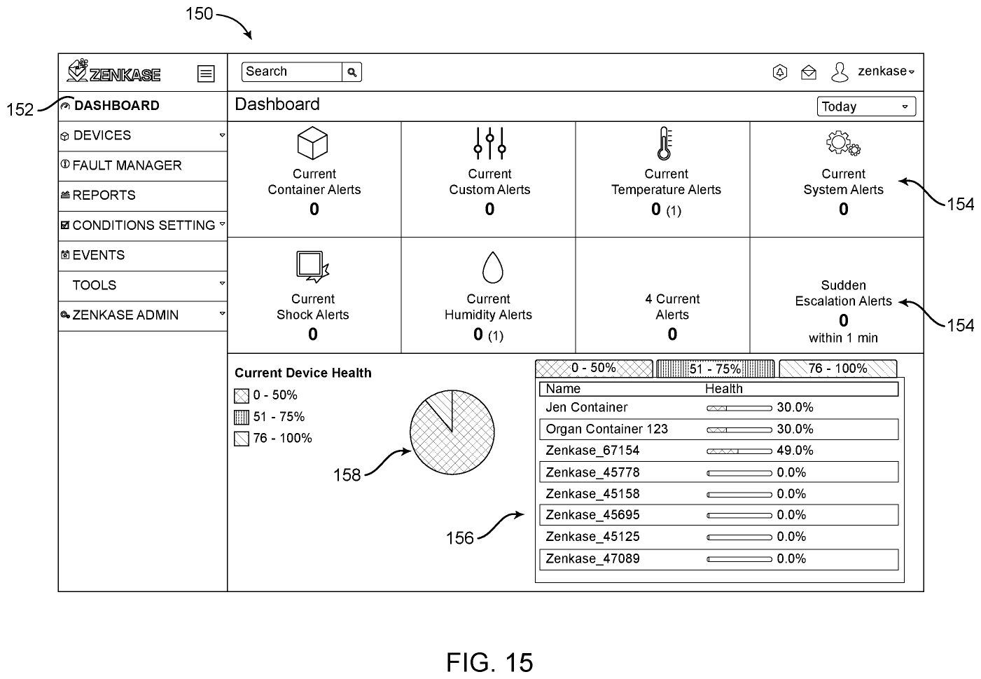

In an alternative embodiment, as shown in FIGS. 15-22, the system 10, 40 of the present invention displays various UIs or graphical user interfaces (GUIs) on the display 120 of the user computer 32, for interacting with the system 10, 40, and specifically for interacting with and controlling the devices 12, 82. As shown in FIG. 15, an interface 150 displays a dashboard screen, either in response to user selection of a dashboard tab 152, or as a default interface at the start of using the system 10, 40. The dashboard screen in FIG. 15 shows the status of a plurality of alerts 154, a list 156 of the various devices 12, 82 listed by their unique identifiers as well as listing their health status, and a graphic 158 representing the overall health of all of the devices 12, 82. The alerts 154 may include container alerts, custom alerts, temperature alerts, system alerts, shock alerts, humidity alerts, sudden escalation alerts, etc. Sudden escalation alerts are triggered based on the frequency and velocity of a failure and how an alert is outputted.

As described below, the “health” of a device 12, 82 reflects the overall state of the device 12, 82, relative to various monitored parameters, e.g., light, temperature, humidity, pressure, vibration and shock.

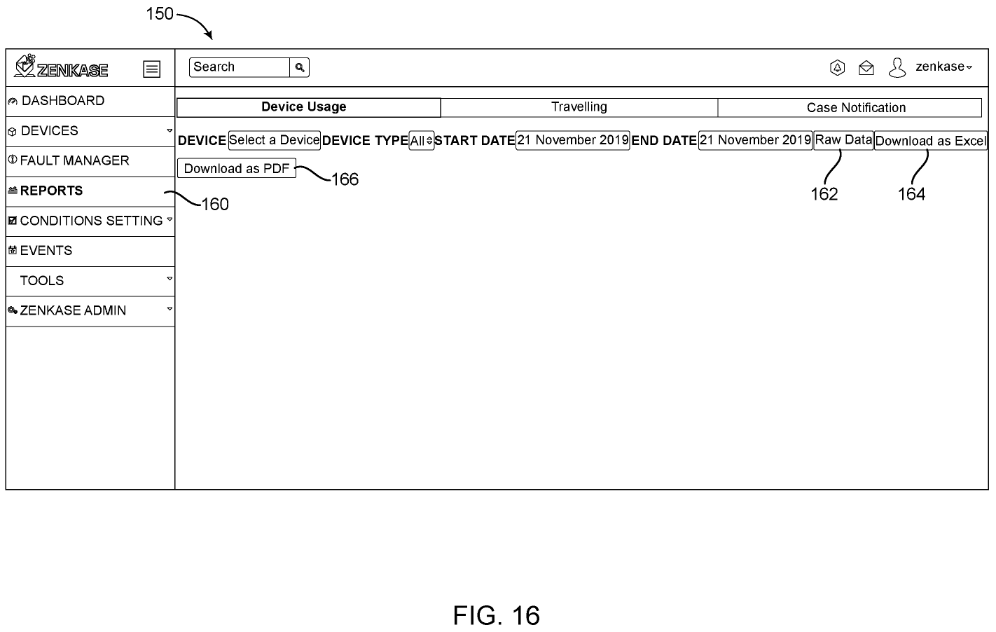

Referring to FIG. 16, the interface 150 shows a reports screen in response to user selection of the reports tab 160. The reports screen lists each device 12, 82, and allows the user to download the report in the form of raw data by user selection of a raw data icon 162, in the form of a MICROSOFT EXCEL spreadsheet by user selection of a download-as-Excel icon 164, or in the form of an ADOBE PDF file by user selection of a download-as-PDF icon 166.

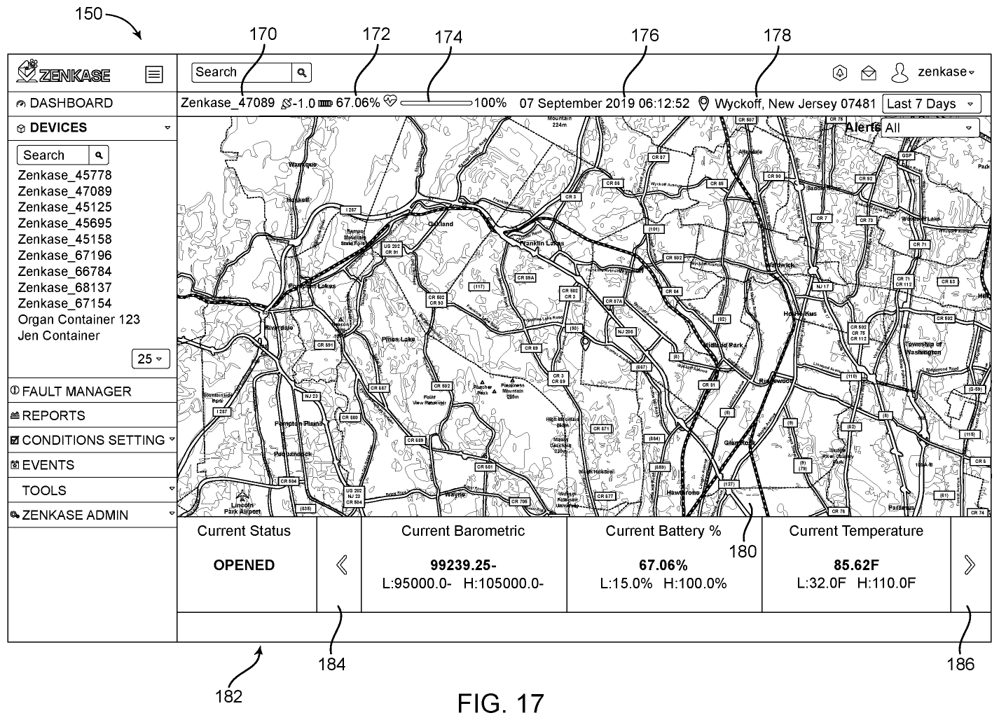

Referring to FIG. 17, the interface 150 shows a device status screen for a specific device 12, 82, such as the device having the unique identifier Zenkase_47089, as indicated by the identifier 170. Other status indicators include a battery life indicator 172, a health indicator 174, the current date and time 176, and the current geographic location 178 of the device 12, 82. The current location may also be shown on a map 180 with a pointer representing the geographic location of the device 12, 82, and in turn the geographic location the associated container 14 or item 42. In addition, a ribbon or bar 182 is displayed, with status indicators of the various parameters being measured. For example, the ribbon or bar 182 shows the current status of the container 14 or item 42 as OPENED; the current barometric pressure with lows and highs also displayed; the current battery life of the device 12, 82, also with lows and highs being displayed; and a current temperature which may be in Fahrenheit by default or which may be set by the user or system administrator, and also displaying lows and highs.

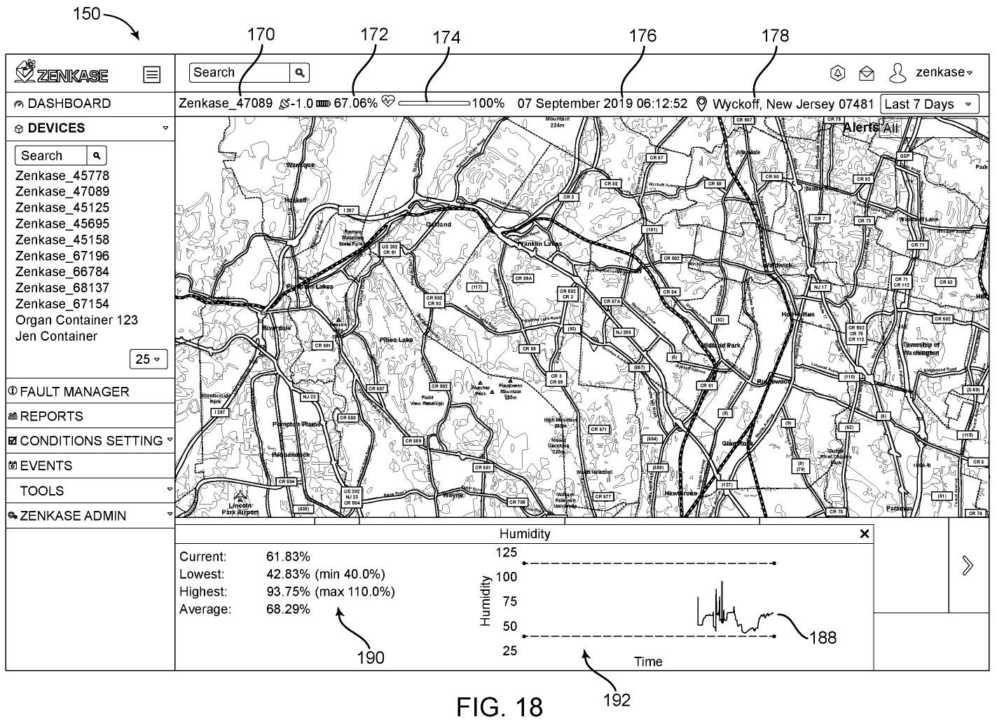

The dashboard 150 may be a GUI, such that actuatable arrows 184, 186, by clicking or pressing on a touchscreen, allow the user using the user computer 32 to scroll through the status indicators of the measured parameters, for example, to scroll leftward or rightward. In addition, each of the status indicators of measured parameters in the ribbon or bar 182 may be actuatable, to display additional information of the selected parameter. For example, by actuating a humidity indicator in the ribbon or bar 182 in FIG. 17, the user computer 32 then displays a pop-up window 188, as shown in FIG. 18, which outputs statistics 190 about the humidity in the environment of the device 12, 82, and in turn of the associated container 12 or item 42. In addition, the pop-up window 188 displays a graph 192 plotting the history of the humidity experienced by the device 12, 82, and in turn of the associated container 12 or item 42.

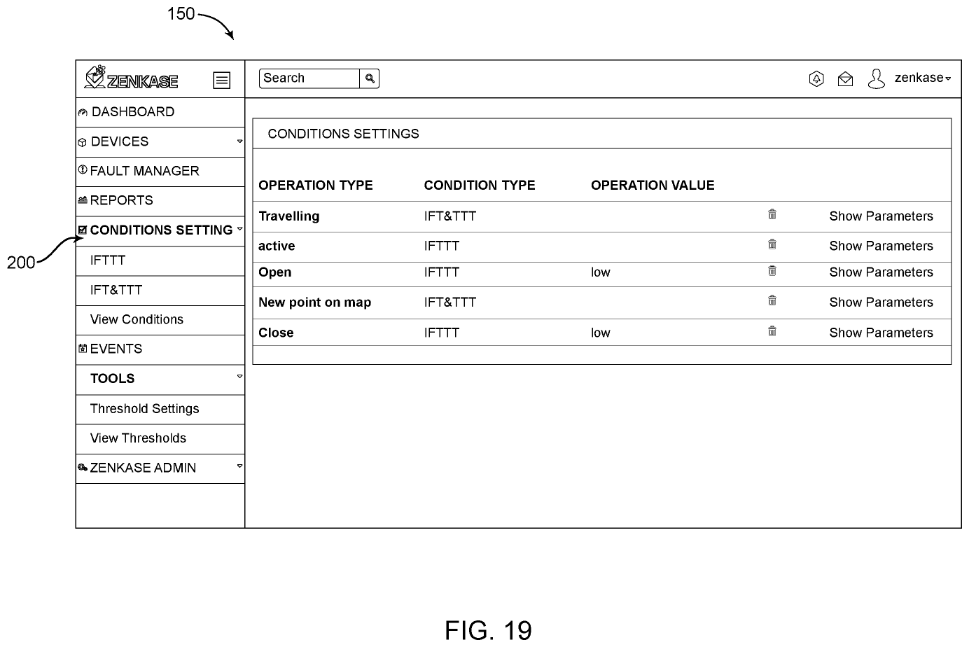

Referring to FIGS. 19-21, the present invention also provides an interface for a user to set conditions, through actuation of a Conditions Setting tab 200 shown on the interface 150. The conditions may be set for If-This-Then-That (IFTTT) conditions or If-This&This-Then-That (IFT&TTT) conditions. An IFTTT condition may be used for a single condition such as when the ambient light detected by a device 12, 82 is below a set illumination level. An IFT&TTT condition may be used for a pair of conditions, for example, a temperature range such as 50° F.<temperature<70° F. (temperature between 50° F. and 70° F.) and a light detected by a device 12, 82. The interface 200 allows the user to determine the operational status for a device 12, 82, such as “traveling” for the device 12, 82 traveling; “active” for the device 12, 82 being turned on for monitoring; “open” for the container which the device 12, 82 is monitoring being in an open configuration; “new point on the map” for the device 12, 82 being newly plotted on an interactive map; and “close” for the container which the device 12, 82 is monitoring being in a closed configuration.

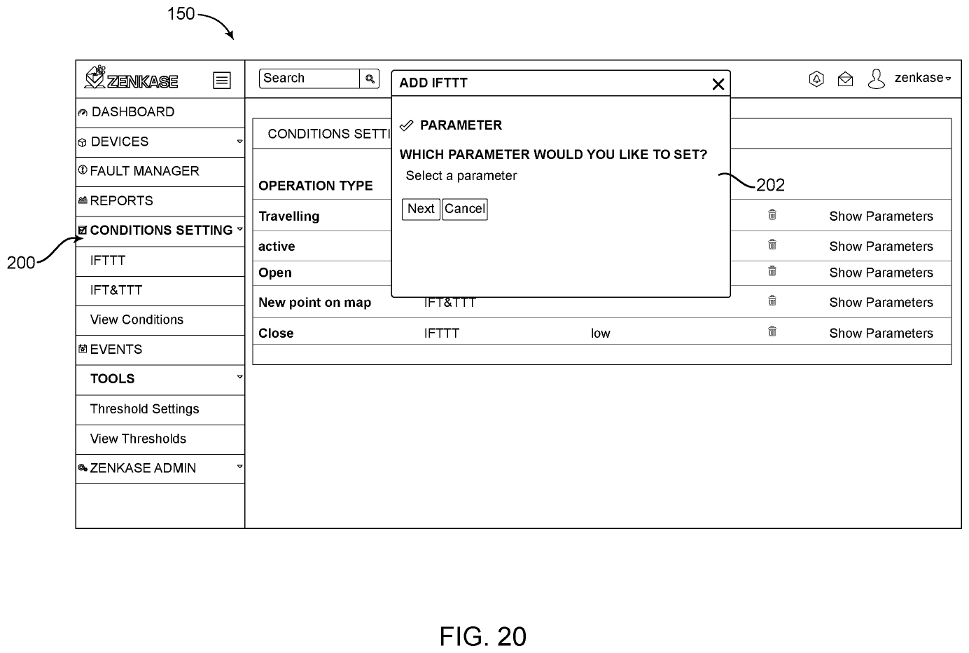

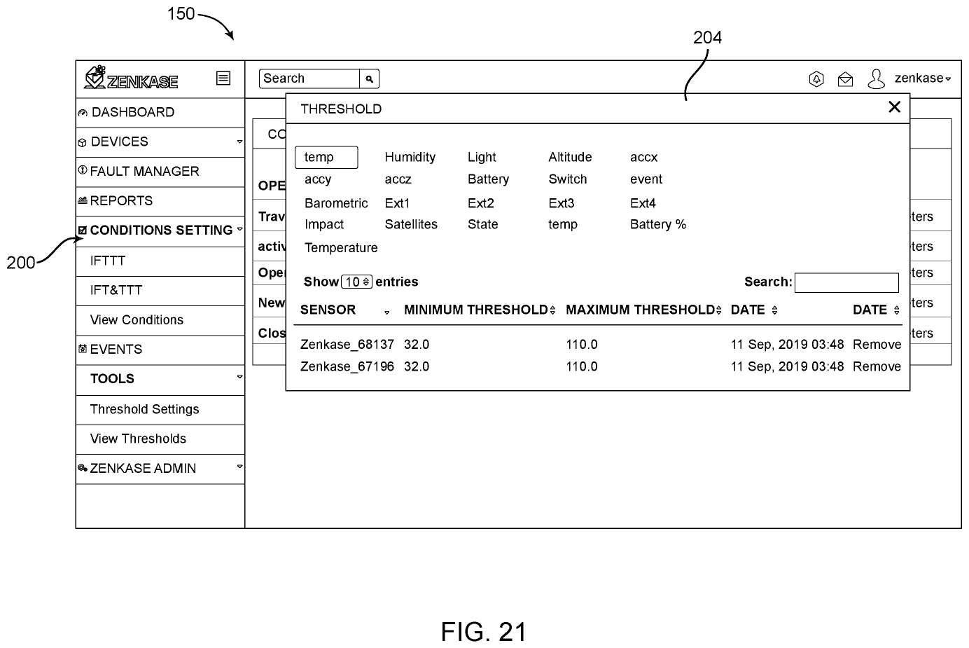

Referring to FIG. 20, actuation of an IFTTT tab generates a pop-up window 202 through which the user sets a parameter which has an IFTTT condition. Similarly, actuation of an IFT&TTT tab also generates a pop-up window through which the user sets a parameter which has an IFT&TTT condition. Referring to FIG. 21, a threshold pop-up window 204 is displayed to the user to allow the user to select one of a number of parameters with threshold settings, such as temperature, humidity, light, altitude, battery power level, barometric pressure, impact, etc.

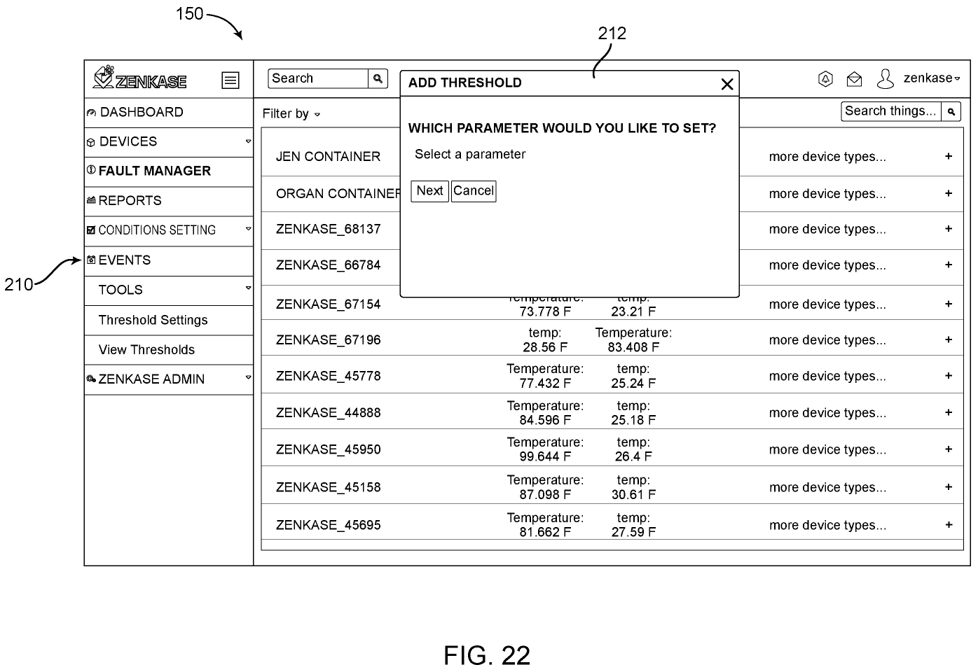

Referring to FIG. 22, the present invention also provides an interface for a user to set events for a specific and selected device 12, 82, such as thresholds or limits for the monitored parameters, e.g., light, temperature, humidity, pressure, vibration and shock, through actuation of an Events tab 210 shown on the interface 150, and through subsequent selection of a specific device 12, 82. A pop-up window 212 prompts the user to select a parameter for which to set a threshold or event. The thresholds are used by the system 10, 40 to determine the “health” 174 (FIGS. 17 and 18) or performance of the overall trip and delivery of a container 12 or an item 42 being transported with the device 12, 82, with the health calculated by a predetermined algorithm, which dynamically processes and takes into account a series of input and data to be predictive of the overall state of the trip. For example, thresholds may be set such that an alarm or warning is generated if 50° F.<temperature<70° F. (temperature between 50° F. and 70° F.). Alternatively, alerts can also be set such that, even if a threshold is set, no alarm or warning is generated. The alerts can be set to ignore violations of the threshold if the violation is within, for example, 10° F. Accordingly, alerts will not be generated if 40° F.<temperature<80° F. (temperature between 40° F. and 80° F.), but would be generated if the temperature is less than 40° F. or if the temperature is greater than 80° F. The user could also program the system of the present invention so that alerts are generated only when a combination of events occur, e.g., temperature exceeds an acceptable threshold and vibration exceeds an acceptable threshold. The generated alerts may be a displayed message to the user, a sound, a color, a changing color or a changing appearance of a symbol displayed on the user computer 32. The generated alerts may be transmitted in the form of a SMS text message, an Email, a phone call, etc.

One motivation for controlling the generation of alerts is to preserve battery life if the power supply 50 is a battery, such as a rechargeable battery. For example, when the battery is low, the device 12, 82 may go into a pre-programmed sleep mode, in which data is collected but not externally transmitted. In addition, the device 12, 82 may continually collect data even if the level of the power supply 50 is low, that is, below a predetermined power threshold, but the device 12, 82 only sends alerts back to, for example, the server 24 or the user computer 32 when a problem is detected. In the example above, the device 12, 82 may be traveling with a container 14 or an item 42 by way of a courier, and so if the temperature exceeds 80° F., a user can be alerted and the user then contacts the courier to rectify the situation to place the device 12, 82 in an environment where the temperature does not exceed 80° F. Rather than continually transmitting data regarding the temperature and using battery life, the device transmits data regarding temperature only when the predetermined threshold is exceeded, thereby preserving battery life in the device.

The present invention provides a predetermined algorithm to calculate an artificial “trip” score for each parameter based on the settings that the user defines as acceptable limits for each parameter, which could be unique for each parameter's health definition. Each trip score could be reported as a percentage. Another predetermined algorithm is provided to sum up the trip score for each measured parameter and to provide a performance index for insurance companies or carriers to hedge their risk or for the operators to understand in a glance what to expect during delivery. Furthermore, the device 12, 82 could be programmed such that an alert is issued when a measured value falls outside the thresholds or limits of any of the set parameters. Thresholds can be set for any single variable or set of variables to define alerts that can be sent to a user or group of users by any standard or known means (a SMS text message, an Email, a phone call, etc.). The system can predict the health during a trip, and check if the trip performance is meeting specific requirements, such as having temperatures or humidity within a predetermined range.

For one user, the set parameters may be heat and GPS location. If the device 12, 82 gets farther from an acceptable location, the health will decrease, or if the temperature rises closer to a threshold, again the health will decrease. For another user the set parameters could be power, pressure, or anything that the device 12, 82 is able to measure. In another example, if a set of devices 12, 82 are required to travel together and a subset of those devices 12, 82 separate, a notification could be sent and/or the trip score will decrease. A web-based user-specific and configurable dashboard is an integral part of the invention. This dashboard can be used for real-time or set frequency monitoring of all or a subset of relevant data including “health” per device and per trip to understand and monitor performance, and data from all sensor inputs for a single device or a set of devices. Furthermore, views can be configured so that a “parent” user that has rights to view the status of multiple devices (which may be assigned to others as “child” view only) can do so with the same flexibility to configure the dashboard as they see fit.

The container 14 may be any container of any size, shape, and dimensions, and may contain any types of items, such as pharmaceuticals, military equipment, jewelry, etc., especially since such items may be very valuable or expensive, so real-time knowledge of the locations of such items is important. Any individual items 42 may be tracked by software for receiving and processing the locations of all of such items according to the Internet of Things (IoT).

The systems 10, 40 and the device 12, 82 are thus configured to allow one or more users to remotely monitor the status of a device 12, 82 in real-time using the cloud-based application and interacting with a web-based interface.

Additional aspects of the present invention may include power saving features, such as aggressive power saving operation by which peripherals such as the sensors 50 and the network interfaces are powered up as little as possible. In addition, the use of WiFi may be configured to reduce network searching to once per hour after, for example, three failed communication attempts. Furthermore, 3G network operations may be configured to only power up if WiFi communications are unavailable. Also, the GPS circuitry and functionality only powers up if a movement is detected, for example, by the accelerometer 68 and/or other sensors 50.

Further aspects of the present invention may include a first-in-first-out (FIFO) buffer as the memory of the PCB 64, such that data packets are always obtained and sent in the order in which the data packets were received. Also, the processor and/or the memory of the PCB 64 may have a small RAM buffer which may be implemented as Flash memory. Any Flash memory only gets written to when there are no communications. In addition, any Flash memory may be analyzed to re-create pointers in memory in the event of power loss to the PCB 64.

Other features of the system 10, 40 may be the use of a plurality of timing sources, such as three timing sources for synchronizing a clock of the PCB 64. In addition, using an accelerometer 68 as a sensor 50, the device 12, 82 may detect impacts to the device 12, 82, and the PCB 64 may use software interrupts to catch every impact event. Furthermore, for any external sensors 50, auto-detection and S/W limits may be implemented. In addition, to implement WiFi communications, multiple WiFi service set identifiers (SSIDs) may be enabled, and the device 12, 82 may automatically connect to open WiFi networks. For power management, the number and/or the frequency of transmissions by the PCB 64 may be reduced when the battery power is low, and multiple packets of data may be consolidated into a single transmission to save power. Also, the processor of the PCB 64 may be a dedicated low-power processor for continuous monitoring of the sensor 50. For example, the present invention includes a logger option for collecting and storing data in a memory 60 of the device 12, 82 if the device 12, 82 does not or cannot connect to the network 22, such as the Internet.

Additional features of the present invention may include the use of application programming interfaces (APIs) for implementing the user interface on the user computer 32 which may be a smart phone. Each application executed by the user computer 32 to implement the system 10 and method of the present invention may be customized, for example, by the user. In an example embodiment, the numerical values in the output fields 130 in the user interface, as shown in FIG. 13, may be customized, for example, to display the values in SI units or in imperial units.

The present invention may be embodied in other specific forms without departing from its spirit or essential characteristics. The described embodiments are to be considered in all respects only as illustrative and not restrictive. The scope of the invention, therefore, will be indicated by claims rather than by the foregoing description. All changes, which come within the meaning and range of equivalency of the claims, are to be embraced within their scope.

What is claimed is:

1. A system comprising:
a network;
at least one monitoring device operatively connected to the network, with each of the at least one monitoring device associated with a respective item, wherein each of the at least one monitoring device monitors a state of the respective item relative to a first parameter, wherein the first parameter is selected from the group consisting of ambient light, humidity, air pressure, vibration, shock, temperature, air quality, and location;
a server for communicating with the at least one monitoring device through the network, for storing a list of a plurality of identifiers, and for storing a plurality of states of the at least one monitoring device, wherein each identifier is at least one character which uniquely identifies a respective item; and
a user computer associated with a user and operatively connected to the server through the network, the user computer including:
an input device for inputting a first identifier and for communicating the first identifier to the server; and
an output device for outputting to the user a first state of a first monitoring device from the at least one monitoring device corresponding to the first identifier;
wherein the first state of the first monitoring device corresponds to a state of a first item of the plurality of items with the first item associated with the first monitoring device.

2. The system of claim 1, wherein the user computer includes an input/output device having a graphical user interface for implementing the input device and the output device.

3. The system of claim 1, wherein the network is the Internet.

4. The system of claim 1, wherein the first monitoring device is attached to the first item by an attachment member.

5. The system of claim 1, wherein the first item is a container.

6. The system of claim 5, wherein the first monitoring device is inside the container.

7. The system of claim 1, wherein the output device includes a display.

8. The system of claim 7, wherein the display displays a dashboard indicating the first state.

9. The system of claim 8, wherein the dashboard allows the user to monitor the state of the first item.

10. The system of claim 8, wherein the dashboard allows the user to monitor the health of the first item, wherein the health is determined from the first state using a predetermined algorithm.

11. A system comprising:
at least one monitoring device, with each of the at least one monitoring device associated with a respective item, wherein each of the at least one monitoring device monitors a state of the respective item relative to a first parameter, wherein the first parameter is selected from the group consisting of ambient light, humidity, air pressure, vibration, shock, temperature, air quality, and location;
a server for communicating with the at least one monitoring device, for storing a list of a plurality of identifiers, and for storing a plurality of states of the plurality of monitoring devices, wherein each identifier is at least one character which uniquely identifies a respective item; and
a user computer associated with a user and operatively connected to the server, the user computer including:
an input device for inputting a first identifier and for communicating the first identifier to the server; and
an output device for outputting to the user a first state of a first monitoring device of the at least one monitoring device corresponding to the first identifier;
wherein the first state of the first monitoring device corresponds to a state of a first item of the plurality of items with the first item associated with the first monitoring device.

12. The system of claim 11, further comprising:
a network for connecting the plurality of devices, the server, and the user computer.

13. The system of claim 11, wherein the output device includes a display.

14. The system of claim 13, wherein the display displays a dashboard indicating the first state.

15. The system of claim 14, wherein the dashboard allows the user to monitor the state of the first item.

16. The system of claim 14, wherein the dashboard allows the user to monitor the health of the first item, wherein the health is determined from the first state using a predetermined algorithm.

17. A system comprising:
a device for monitoring a state of an item relative to a parameter; and
a user computer for outputting a health of the item to a user associated with the user computer, wherein the health is determined from the state using a predetermined algorithm.

18. The system of claim 17, wherein the device is attached to the item by an attachment member.

19. The system of claim 17, wherein the item is a container.

20. The system of claim 19, wherein the device is inside the container.
